(19) United States
(12) Patent Application Publication
(10) Pub. No.: US 2010/0211955 A1
(43) Pub. Date: Aug. 19, 2010

(54) CONTROLLING 32/64-BIT PARALLEL THREAD EXECUTION WITHIN A MICROSOFT OPERATING SYSTEM UTILITY PROGRAM

(75) Inventor: Robert F. Terry, Old Hickory, TN (US)

Correspondence Address: MILES & STOCKBRIDGE PC, 1751 PINNACLE DRIVE, SUITE 500, MCLEAN, VA, 22102-3833, US

(73) Assignee: CWI, Ellwood City, PA (US)

(21) Appl. No.: 12/440,305

(22) PCT Filed: Sep. 7, 2007
(86) PCT No.: PCT/US07/77910

§ 371 Date: Apr. 26, 2010

Related U.S. Application Data
(60) Provisional application No. 60/824,814, filed on Sep. 7, 2006.

(51) Int. Cl. G06F 9/46

(52) U.S. Cl. 718/103

(57) ABSTRACT

A method of programming operating system (O/S) utility C and C++ programs within the Microsoft professional development 32/64-bit parallel threads environment, includes providing a computer unit, which can be a 32/64-bit Microsoft PC O/S, or a 32/64-bit Microsoft Server O/S, a Microsoft development tool, which is the Microsoft Visual Studio Development Environment for C and C++ for either the 32-bit O/S or the 64-bit O/S.

### CROSS REFERENCE TO RELATED APPLICATION

This application claims benefit of priority to U.S. Provisional Patent Application No. 60/824,814, filed Sep. 7, 2006, which is herein incorporated in its entirety by reference.

### FIELD OF THE INVENTION

The present invention relates generally to the field of operating system (O/S) utility programming, and more particularly, but not exclusively, to operating systems and methods of monitoring various (unlimited) events occurring real-time within a 32/64-bit Microsoft PC or Server O/S.

### BACKGROUND OF INVENTION

As the importance of programming expands in business and organizations, and as Computers become faster and more automation is present within PCs and Servers running a Microsoft Corporation operating system (O/S), there is an increasing need for professional developers to design and develop programs that can effectively and efficiently execute and co-exist without utilizing significant resources. This is especially true for those resources that pertain to CPU utilization (cycles used/percentage) and memory usage. The terms Microsoft PC, Microsoft Server, Microsoft computer, Microsoft 32-bit computer, and/or any other similar variations and combinations using Microsoft to describe a specific computer, device and/or server may be used interchangeably to mean a computer, device and/or server on which a Microsoft O/S is implemented.

As an example, a Microsoft 32-bit computer, or Microsoft 64-bit computer, may be purchased with already installed utilities and programs, such as, for example, anti-virus, spyware, firewall, word processing applications, etc., that require a great deal of CPU cycles (in other words, a high percentage of the available CPU cycles) and a great deal of memory. Microsoft 32/64-bit computers may come with numerous third-party programs that attempt to utilize as many CPU cycles (i.e., use a high percentage of available CPU cycles) and as much memory that is available during the time of program execution.

Thus there is a need for programs that will not drain significant resources (that is, CPU cycles and memory) from a computer on which it is implemented. Likewise, programs should not inhibit the computer from performing its assigned task(s) and/or annoy a user who is utilizing the computer due to “sluggish performance.” Therefore, an O/S utility program that is defined to execute (i.e., run), from the time a computer is turned on, until the time the computer is turned off, generally, needs to be designed and developed to achieve optimum operational (i.e., execution) results in regards to execution efficiency using CPU cycles and available memory.

While the Microsoft operating system “Threading Model” design architecture substantially changes from the 32-bit O/S to the 64-bit O/S, the 64-bit Microsoft O/S, such as, for example, Vista, will continue to support a 32-bit “Threading Model” design within the 64-bit Vista O/S.

### SUMMARY

In accordance with an embodiment of the present invention, there is provided a method of implementing a programming design, which is adapted to be applied to Microsoft C/C++ programs and that can initiate parallel threads to monitor almost an unlimited number of events reported by the operating system in a real-time environment. The method is further adapted to initiate the parallel threads without any noticeable performance degradation by the user and an extremely small impact to the overall computer usage, regarding CPU cycles and memory utilization.

### BRIEF DESCRIPTION OF DRAWINGS

Non-limiting and non-exhaustive embodiments of the present invention are described with reference to the following figures, wherein like reference numerals refer to like parts throughout the various views unless otherwise precisely specified.

FIG. 1 is a C/C++ pseudocode representation of a program that, when executed, creates a general programming framework that may be used to execute the inventive method of managing the efficient execution of parallel threads, in accordance with at least one embodiment of the present invention.

FIG. 2 is a general flow diagram of the mechanics (i.e., control) (i.e., control) and interlinks between parallel threads, a thread management system and an actual O/S and how these functions may be adapted to continuously execute in order to effectively manage the efficiency of executing parallel threads, in accordance with at least one embodiment of the present invention.

FIG. 3 is a detailed flow diagram of the mechanics (i.e., control) and interlinks between a single parallel thread and how this particular parallel thread may activate a thread management system function, in accordance with at least one embodiment of the present invention.

FIG. 4 is a detailed flow diagram of the mechanics (i.e., control) within a thread management function and how it may perform its specific tasks of determining a thread priority and thread speed of a specific parallel thread that called (i.e., initiated) the thread management function, in accordance with at least one embodiment of the present invention.

FIG. 5 is a detailed flow diagram of the mechanics (i.e., control) within a thread management function, after parameters been analyzed to determine a speed of a thread and that the thread is a high priority thread, in accordance with at least one embodiment of the present invention.

FIG. 6 is a detailed flow diagram of the mechanics (i.e., control) within a thread management function, after parameters have been analyzed to determine a speed of a thread and that the thread is a medium priority thread, in accordance with at least one embodiment of the present invention.

FIG. 7 is a detailed flow diagram of the mechanics (i.e., control) within the thread management function, after parameters have been analyzed to determine a speed of a thread and that the thread is a low priority thread, in accordance with at least one embodiment of the present invention.

FIG. 8 is a detailed flow diagram of a method of efficiently managing parallel thread execution, in accordance with at least one embodiment of the present invention.

FIG. 9 is a block diagram of a computer system that may be used in accordance with at least one embodiment of the present invention.

FIG. 10 is a diagram of a multiple network system that may be used in accordance with at least one embodiment of the present invention.

### DETAILED DESCRIPTION OF ILLUSTRATED EMBODIMENTS

In the description herein, in accordance with one or more embodiments of the present invention, general details may be provided in pseudocode, such as C/C++ structures, classes, and variables, to provide a general understanding of the programming methods to assist in an understanding of the described embodiments. However, it is contemplated that some embodiments of the inventive method may be practiced without one or more specific details, or in accordance with other programming methods. References throughout this specification to “one embodiment” or “an embodiment” means that a particular feature, structure or characteristic described in connection with the embodiment is included in at least one embodiment of the present invented method. Thus, the appearance of the phrases “in one embodiment” or “in an embodiment” in places throughout this specification are not necessarily all referring to the same embodiment. Furthermore, the particular features, structures, or characteristics may be combined in any suitable manner in one or more various embodiments.

As an overview, a programmer can design parallel threads using, for example, the “Threading Model” design of the Microsoft O/S. In accordance with one embodiment of the invention, a method may include (i.e., comprise) creating a framework, creating a working function and using that function to manage multiple parallel threads for the purpose of monitoring events and collecting information in a real-time environment from virtually an unlimited amount of O/S functions that may execute and control a Microsoft computer. For example, a parallel thread may be established to monitor communications, such as Tcp, Udp, Icmp data flow to/from the Microsoft computer. In another example, a parallel thread may be established to monitor an O/S internal process manager (e.g., a stack), which may include “.exe” programs, which enter/exit the process manager (e.g., a stack); and any associated programs, for example, dynamic link libraries (“.dll”) which are interlinked directly into each executing “.exe” program currently within the process manager (stack). In yet another example, a parallel thread may be used to monitor a specific application and any windows created and destroyed by the specific application during user activity. In yet another example, a parallel thread may initiate a thread to perform an independent analysis of a hard drive, including, for example, analysis of the files installed on the hard drive and monitor those files by calling functions that interface directly into an O/S file management system.

In accordance with one or more embodiments of the present invention, a method includes monitoring various (unlimited) events occurring real-time within a 32/64-bit Microsoft PC or Server O/S, by implementing parallel threaded C/C++ programs that can execute, continuously cycle and co-exist within an executing Microsoft PC or Server O/S in an extremely efficient manner.

In accordance with one or more embodiments of the present invention, the O/S utility may be developed or implemented in a variety of programming languages ranging from low-level, programming languages (e.g., but not limited to, assembler) to high-level programming languages (e.g., but not limited to, C++, Visual Basic, Java, Java Beans, etc.). The O/S utility may be stored or encoded as an executable file on a machine-readable and/or a computer-readable medium (e.g., but not limited to, a floppy disk, a hard drive, a flash drive, a bubble memory, a Read Only Memory (ROM), a Random Access Memory (RAM), or the like) and/or hardwired into one or more integrated circuits (e.g., an Electrically Erasable Programmable Read Only Memory (EEPROM), an Erasable Programmable Read Only Memory (EPROM), etc.).

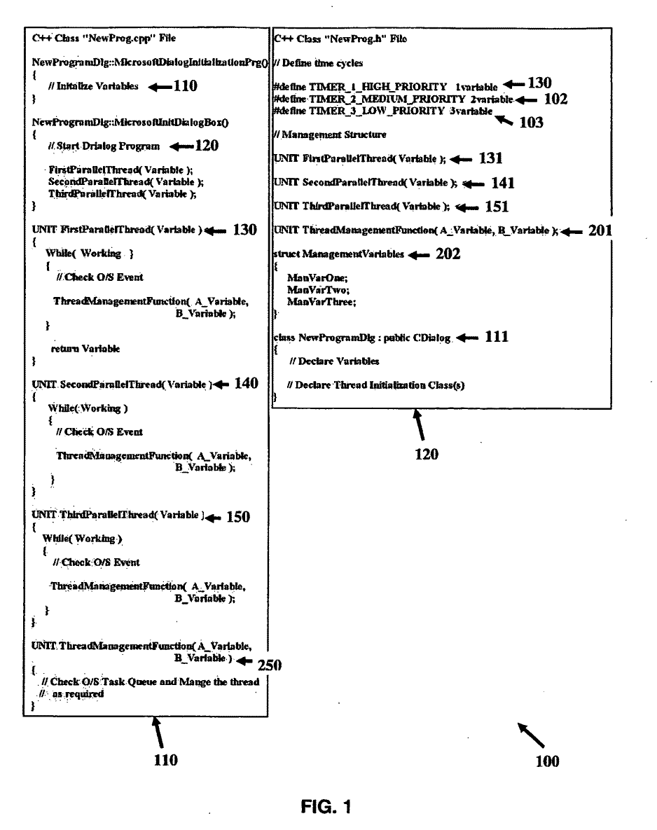

FIG. 1 is a C/C++ pseudocode representation of a program that, when executed, can create a general programming framework useful to execute the inventive method of managing the efficient execution of parallel threads, in accordance with at least one embodiment of the present invention. In FIG. 1, there is shown an example of creating a programming framework that can implement the present invention. In at least one embodiment, a pseudocode program 100 can be provided in the general framework of a Microsoft C/C++ application to include a “.cpp” program (i.e., class) file and an “.h” program definition (i.e., class definition) file.

In at least one embodiment, the “.h” program file can define, in general, time cycle variables 101, 102, 103, parallel functions 131, 141, 151, a thread management function 201, and a structure 202 (identified as “struct”). In general, structure 202 can contain certain key management functions and an actual program class 110, which is identified in FIG. 1 as CDialog and is defined as a “NewProgramDlg” class. Within this class, the pseudocode description of the classes to initiate and execute the parallel threads can be defined as stated in the pseudocode in FIG. 1.

In accordance with an embodiment of the present invention, in general, the framework of FIG. 1 is designed to create a management framework within the Microsoft “Threading Model” that does not depend on the normal Microsoft Sleep( ) function, as defined and used in the Microsoft O/S, Unix O/S and Linux O/S. In general, the normal Microsoft Sleep( ) function causes a thread to relinquish the remainder of its assigned execution time slice and become unrunnable for an interval based on a value specified in the “( )” argument that is expressed, typically, in milliseconds. For example, sleep(2000) would cause a thread to relinquish its remaining time slice and set the minimum time interval for which execution of the thread is to be suspended at 2000 milliseconds.

In FIG. 1, a class (i.e., a program) 120 may be executed, which also starts (i.e., initiates) three parallel threads 130, 140, 150, respectively. At this point, the class also starts and makes available a TheadManagementFunction( ) 250, which is executed, or called) by each parallel thread.

Unfortunately, the standard Microsoft Sleep( ) function does not contain the mechanical (i.e., computational) efficiency necessary to execute, manage and control multiple parallel threads, which are executing and collecting O/S event data as the O/S boots and executes from the time the computer is turned on, until the time the computer is turned off.

In contrast, once at least one framework is established, then the parallel threads may be executed and managed by a ThreadManagementFunction( ) 250 as described in the embodiment of FIG. 1.

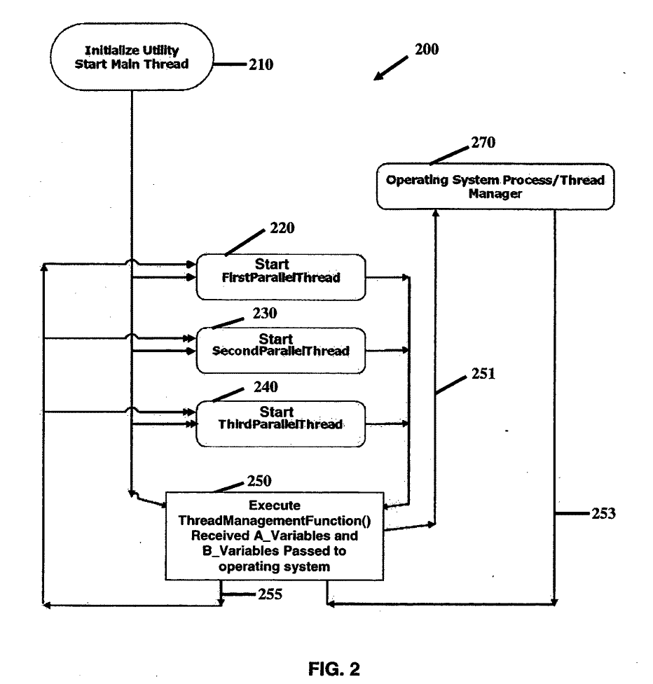

FIG. 2 is a general flow diagram of the mechanics (i.e., control) and interlinks between parallel threads, a thread management system and an actual O/S, and how these functions may be adapted to continuously execute in order to effectively manage the efficiency of executing parallel threads, in accordance with an embodiment of the present invention. In FIG. 2, in general, a method 200 is shown that may start with an initialize utility that can be executed (210) and a class (i.e., program) that can be executed (210) that in turn may start parallel threads and may optionally initiate and make available ThreadManagementFunction( ) 250, which subsequently may be executed (i.e., called) by each parallel thread.

In accordance with an embodiment of the present invention, in FIG. 2, the method 200 can commence by an initial program utility being started (i.e., executed) 210 from a single thread, which may be defined as an “Initialize Utility Start Main Thread”. Following the start 210 of the single thread, FirstParallelThread 130 may be started 220, SecondParallelThread 140 may be started 230 in parallel with the starting 220 of FirstParallelThread 130, ThirdParallelThread 150 may be started 240 in parallel with the starting 220 of FirstParallelThread 130 and the starting 230 of SecondParallelThread 140, and ThreadManagementFunction( ) 250 may be started 250 in parallel with the three parallel threads. Each time the parallel threads cycle, in other words each time FirstParallelThread 130, SecondParallelThread 140, and ThirdParallelThread 150 are executed 220, 230, 240, respectively, they individually call 221, 231, 241, respectively, ThreadManagementFunction( ) 250. ThreadManagementFunction( ) 250 in turn can query 251 an O/S Process/Thread Manager 270 for information regarding the three parallel threads, and O/S Process/Thread Manager 270 can send 253 the requested information back to ThreadManagementFunction( ) 250, which sends (255) control of the execution back to the one of the three parallel threads that called ThreadManagementFunction( ) 250.

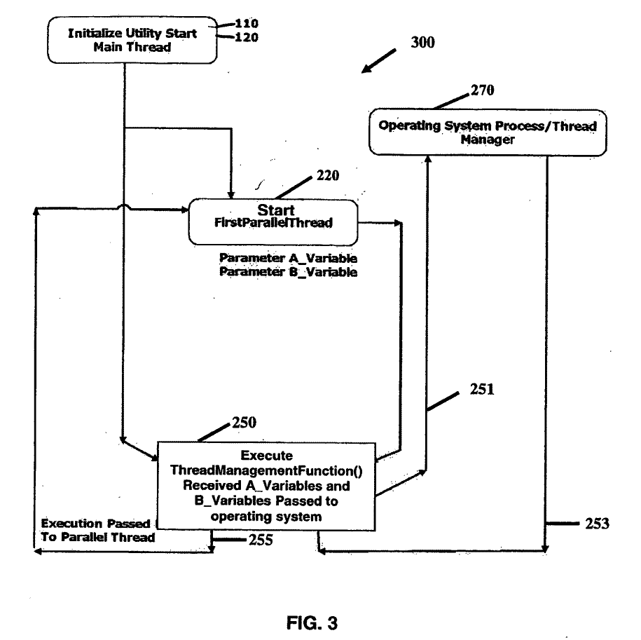

FIG. 3 is a detailed flow diagram of the mechanics (i.e., control) and interlinks between a single parallel thread and showing a method 300 in which this particular parallel thread may activate a thread management system function, in accordance with an embodiment of the present invention. In FIG. 3, the method 300 can commence with the “Initialize Utility Start Main Thread” being started (210), which in turn starts (220) FirstParallelThread( ) 130 and assigns a thread priority value to a parameter A_Variable and a thread speed value to a parameter B_Variable. When FirstParallelThread( ) 130 completes a cycle (i.e., an execution loop), FirstParallelThread( ) 130 calls (221) ThreadManagementFunction( ) function 250 and sends values for the A-Variable (i.e., priority) and the B-Variable (i.e., speed) to ThreadManagementFunction( ) function 250. While executing (250) ThreadManagementFunction( ) function 250 receives parameters for the A_Variable and the B_Variable from FirstParallelThread( ) 130 and adjusts the value of the B_variable, based on the value of the A_variable ThreadManagementFunction( ) function 250 sends (251) a query with the adjusted value of the B-variable to an Operating System Process/Thread Manager 270, which sends information to the O/S. Once the Operating System Process/Thread Manager 270 completes its processing, it sends (253) a notice of its completion back to ThreadManagementFunction( ) function 250, which then exits and sends (255) execution control back to FirstParallelThread( ) 130, which may then start its next operational cycle (loop). Processing may then continue as described above with FirstParallelThread( ) 130 again calling (221) ThreadManagementFunction 250 and sending the A-Variable and B-Variable values to ThreadManagementFunction 250.

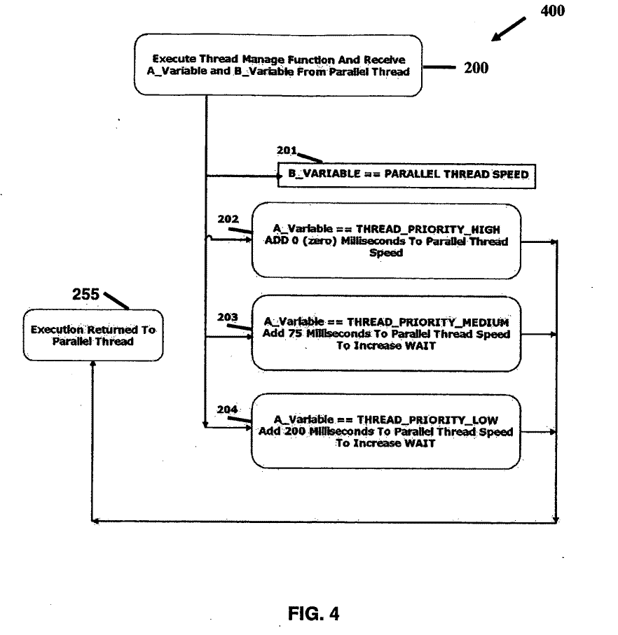

FIG. 4 is a detailed flow diagram of a method 400 illustrative of the mechanics (i.e., control) within a thread management function and that shows how it may perform its specific tasks of determining a thread priority and thread speed of a specific parallel thread that called (that is, initiated) the thread management function, in accordance with an embodiment of the present invention. In the method 400 of FIG. 4, after the executing (250) ThreadManagementFunction( ) 250 receives the A_Variable and B_Variable parameters from a parallel thread, it performs an analysis on the A_Variable and B_Variable parameters to determine the priority level of the thread. Specifically, in the embodiment in FIG. 4, a parallel thread speed variable can be set to equal the value of the B-Variable parameter. In addition, there are three sub-functions within the ThreadManagementFunction( ) 250 that may be used to manage the parallel thread by varying the B_Variable parameter value based on the A_Variable parameter value. For example, if the A_Variable has a THREAD_PRIORITY_HIGH value, ThreadManagementFunction( ) 250 will run function 202, but not actually add 0 milliseconds to the parallel thread speed, since adding 0 does not change the B_Variable parameter value. If the A_Variable has a THREAD_PRIORITY_MEDIUM value, ThreadManagementFunction( ) 250 will run function 203 to add 75 milliseconds to the parallel thread speed, i.e., the B_Variable. If the A_Variable has a THREAD_PRIORITY_LOW value, ThreadManagementFunction( ) 250 will run function 204 to add 200 milliseconds to the parallel thread speed, i.e., the B_Variable. Once the execution is completed, the ThreadManagementFunction( ) 250 will exit and return (255) execution back to the parallel thread that called ThreadManagementFunction( ) 250.

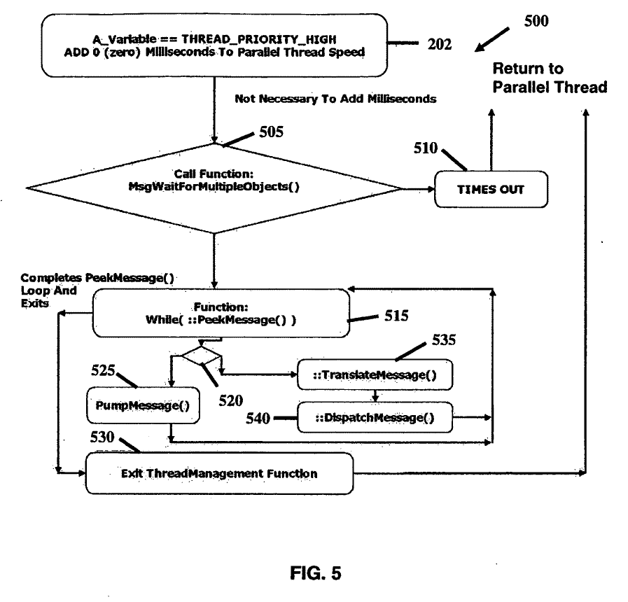

FIG. 5 is a detailed flow diagram of a method 500 illustrative of the mechanics (i.e., control) within a thread management function, in which after parameters have been analyzed to determine a speed of a thread and that the thread is a high priority thread, in accordance with an embodiment of the present invention. In the method 500 shown in FIG. 5, in accordance with the present embodiment, specific techniques (i.e., mechanics) that may be implemented within the sub-function THREAD_PRIORITY_HIGH 202 are illustrated. Because this is a high priority thread and no time delay is used, the B_Variable parameter is not changed.

For example, in FIG. 5, in accordance with the present embodiment, a first function in sub-function THREAD_PRIORITY_HIGH 202 can call a MsgWaitForMultipleObjects( ) function 505 with a parameter QS_ALLINPUT, which causes the function to look for any message in the queue. As a result, MsgWaitForMultipleObjects( ) function 505 can receive all messages from the internal operating system queue. If MsgWaitForMultipleObjects( ) function 505 times out 510, it means that the operating system queue is empty and the MsgWaitForMultipleObjects( ) function 505 can instruct ThreadManagementFunction( ) function 250 to exit and return back to the parallel thread that called ThreadManagementFunction( ) function 250. However, if the MsgWaitForMultipleObjects( ) function 505 does not time out, the MsgWaitForMultipleObjects( ) function 505 will enter a loop and initially call a PeekMessage( ) function 515. After PeekMessage function 515 is called a condition is tested to determine (520) whether the cross-platform development environment exists by testing for #ifdef_AFX_H_ and applying a Boolean variable (true or false). If it is determined (520) that the cross-platform_AFX_H_ exists, then PeekMessage( ) function 515 can execute a PumpMessage( ) function 525 within the operating system and waits for PumpMessage( ) function 525 to complete its operation. Once PumpMessage( ) function 525 completes its operation, it returns execution to PeakMessage( ) function 525, which then exits (530) ThreadManagementFunction( ) function 250 to return to the parallel thread that called ThreadManagementFunction( ) function 250.

If it is determined (520) that the cross-platform_AFX_H_ does not exist, then PeekMessage function 515 can execute a TranslateMessage( ) function 535 which executes a DispatchMessage( ) function 540. The TranslateMessage( ) function 535 translates virtual-key messages into character messages and posts the character messages to the calling thread's message queue, to be read the next time the thread calls a GetMessage function or a PeekMessage function. DispatchMessage( ) function 540, which can dispatch a message to a window procedure, and may be used to dispatch a message retrieved by the GetMessage function. When TranslateMessage( ) function 535 and DispatchMessage( ) function 540 complete, the loop can return to PeakMessage( ) function 515, which will then exit to ThreadManagementFunction( ) function 250.

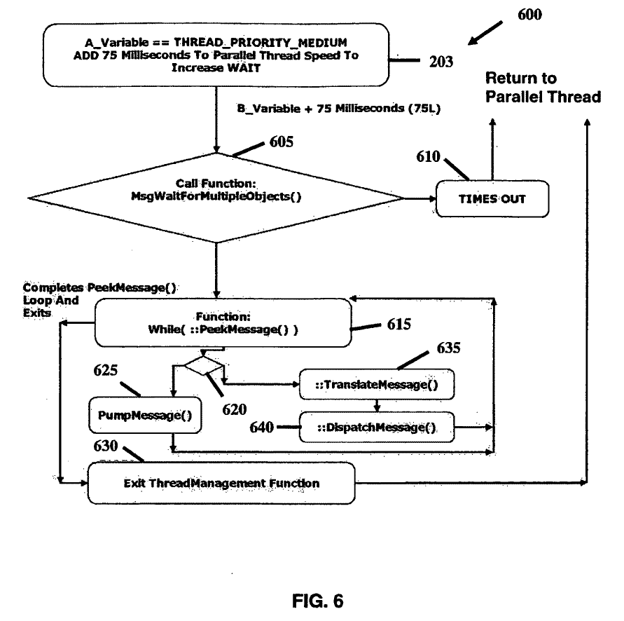

FIG. 6 is a detailed flow diagram of a method 600 of performing a thread management function, after parameters have been analyzed to determine a speed of a thread and that the thread is a medium priority thread, in accordance with an embodiment of the present invention. In FIG. 6, in accordance with the present embodiment, specific techniques (i.e., mechanics) that may be implemented within the sub-function THREAD_PRIORITY_MEDIUM 203 are illustrated. Because this is a medium priority thread, the parallel thread processing speed B_Variable is increased by 75 milliseconds (75 L) to slow the thread cycle, thereby requiring less CPU cycles due to the slower processing time cycle.

For example, in FIG. 6, in accordance with the present embodiment, the method 600 can commence a first function in sub-function THREAD_PRIORITY_MEDIUM 204 that is performed to call a MsgWaitForMultipleObjects( ) function 605 with a parameter QS_ALLINPUT, which causes the function to look for any message in the queue. As a result, MsgWaitForMultipleObjects( ) function 605 can receive all messages from the internal operating system queue. If MsgWaitForMultipleObjects( ) function 605 times out 610, it means that the operating system queue is empty, in which case the MsgWaitForMultipleObjects( ) function 605 can instruct ThreadManagementFunction( ) function 250 to exit and return back to the parallel thread that called ThreadManagementFunction( ) function 250. However, if MsgWaitForMultipleObjects( ) function 605 does not time out, MsgWaitForMultipleObjects( ) function 605 can enter a loop and call a PeekMessage( ) function 615. After PeekMessage function 615 is called, a condition can be tested to determine (620) whether the cross-platform development environment exists by testing for #ifdef_AFX_H_ and applying a Boolean variable (true or false). If it is determined (620) that the cross-platform_AFX_H_ exists, then PeekMessage( ) function 615 can execute a PumpMessage( ) function 625 within the operating system and wait for PumpMessage( ) function 625 to complete its operation. Once PumpMessage( ) function 625 completes its operation, it returns execution to PeakMessage( ) function 625, which then exits (630) ThreadManagementFunction( ) function 250 to return to the parallel thread that called ThreadManagementFunction( ) function 250.

If it is determined (620) that the cross-platform_AFX_H_ does not exist, then PeekMessage function 615 can execute a TranslateMessage( ) function 635 which can execute a DispatchMessage( ) function 640. TranslateMessage( ) function 635 can translate virtual-key messages into character messages and post the character messages to the calling thread's message queue, to be read the next time the thread calls a GetMessage function or a PeekMessage function. DispatchMessage( ) function 640 dispatches a message to a window procedure. In at least one embodiment, DispatchMessage( ) function 640 can be used to dispatch a message retrieved by GetMessage function. When TranslateMessage( ) function 635 and DispatchMessage( ) function 640 complete, the loop can return to PeakMessage( ) function 615, which will then exits to ThreadManagementFunction( ) function 250.

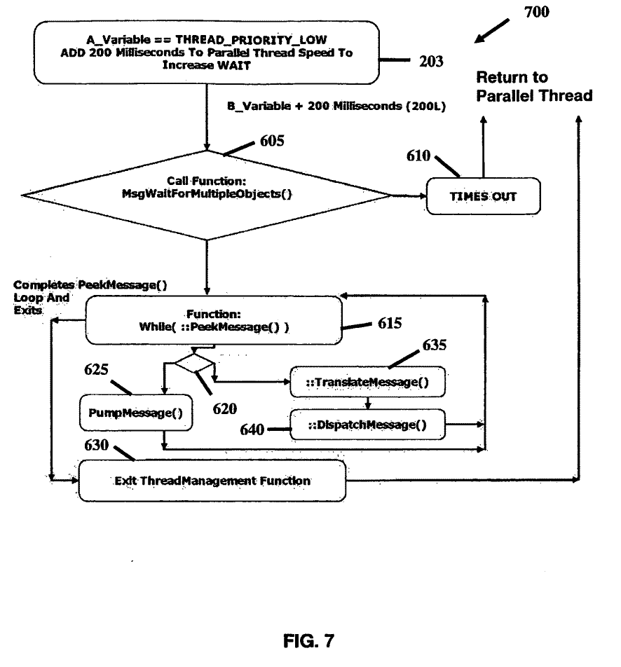

FIG. 7. is a detailed flow diagram of a method 700 performed by the thread management function, after the parameters have been analyzed to determine a speed of a thread and that the thread is a low priority thread, in accordance with an embodiment of the present invention. In FIG. 7, in accordance with the present embodiment, specific techniques (i.e., mechanics) that may be implemented within the sub-function THREAD_PRIORITY_LOW 204 are illustrated. Because this is a low priority thread, the parallel thread processing speed B_Variable can increased by 200 milliseconds (200 L) to slow the thread cycle, thereby requiring less CPU cycles due to the slower processing time cycle.

For example, in FIG. 7, in accordance with the present embodiment, a first function in sub-function THREAD_PRIORITY LOW 204 can call is a MsgWaitForMultipleObjects( ) function 705 with a parameter QS_ALLINPUT, which causes the function to look for any message in the queue. As a result, MsgWaitForMultipleObjects( ) function 705 can receive all messages from the internal operating system queue. If MsgWaitForMultipleObjects( ) function 505 times out 510, it means that the operating system queue is empty and MsgWaitForMultipleObjects( ) function can 505 instruct ThreadManagementFunction( ) function 250 to exit and return back to the parallel thread that called ThreadManagementFunction( ) function 250. However, if MsgWaitForMultipleObjects( ) function 705 does not time out, MsgWaitForMultipleObjects( ) function 705 can enter a loop and initially call a PeekMessage( ) function 715. After PeekMessage function 715 is called, a condition can be tested to determine (720) whether the cross-platform development environment exists by testing for #ifdef_AFX_H_ and applying a Boolean variable (true or false). If it is determined (720) that the cross-platform_AFX_H_ exists, then PeekMessage( ) function 715 can execute a PumpMessage( ) function 725 within the operating system and wait for PumpMessage( ) function 725 to complete its operation. Once PumpMessage( ) function 725 completes its operation, it return execution to PeakMessage( ) function 725, which then exits (730) ThreadManagementFunction( ) function 250 to return to the parallel thread that called ThreadManagementFunction( ) function 250.

If it is determined (720) that the cross-platform_AFX_H_ does not exist, then PeekMessage function 715 can execute a TranslateMessage( ) function 735 which executes a DispatchMessage( ) function 740. TranslateMessage( ) function 735 can translate virtual-key messages into character messages and post the character messages to the calling thread's message queue, to be read the next time the thread calls a GetMessage function or a PeekMessage function. DispatchMessage( ) function 740, which dispatches a message to a window procedure, may be used to dispatch a message retrieved by the GetMessage function. When TranslateMessage( ) function 735 and DispatchMessage( ) function 740 complete, the loop can return to PeakMessage( ) function 715, which will then exit to ThreadManagementFunction( ) function 250.

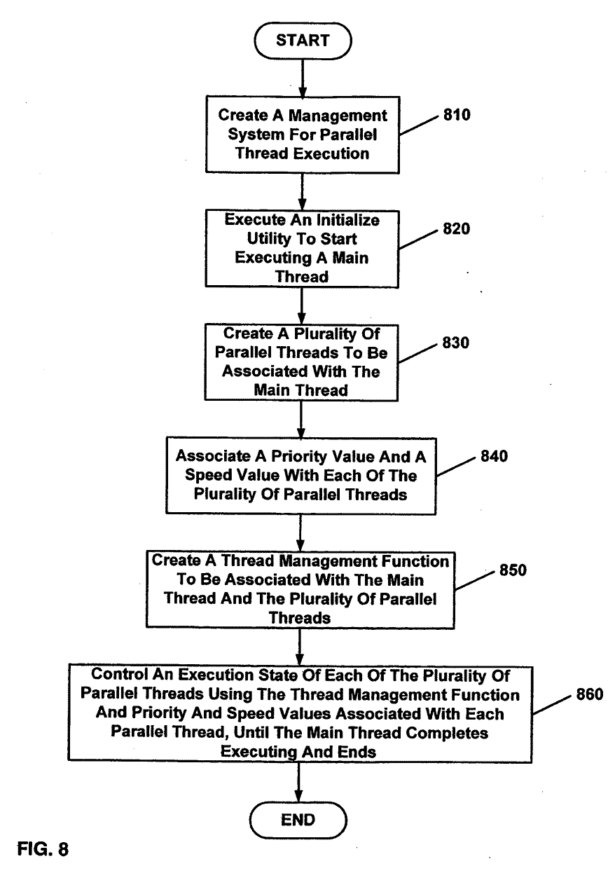

FIG. 8. is a detailed flow diagram of a method 800 of efficiently managing parallel thread execution, in accordance with an embodiment of the present invention. In FIG. 8, the method may include creating (810) a management system for parallel thread execution, executing (820) an initialize utility to start executing a main thread, and creating (830) multiple parallel threads to be associated with the main thread. The method may further include associating (840) a priority value and a speed value with each of the multiple parallel threads, and creating (850) a thread management function to be associated with the main thread and the multiple parallel threads. The method may still further include controlling (860) an execution state of each of the multiple parallel threads using the thread management function and priority and speed values associated with each parallel thread, until the main thread completes executing and ends.

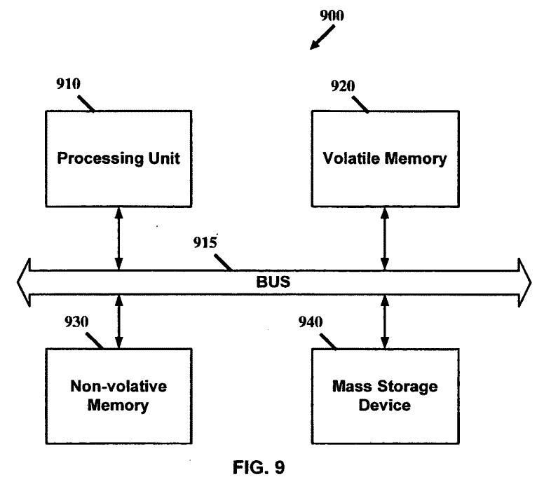

FIG. 9 is a block diagram of a computer system that may be used in accordance with an embodiment of the present invention. In FIG. 9, a computer system 900 may include, but is not limited to, a processing unit (e.g., a processor) 910 connected to a bus 915 to enable processing unit 910 to have two-way communication across bus 915. The processing unit 910 may be a microprocessor, microcontroller, or the like, such as, for example, but not limited to, an Intel Pentium, Xenon, etc. microprocessor. In addition, processing unit 910 may be adapted to operate under the control of a variety of operating systems, for example, but not limited to, a Microsoft 32-bit and/or 64-bit operating system. Computer system 900 may also include a volatile memory (e.g., a random access memory (RAM)) 920 to store executable instructions and information/data to be used by the executable instructions when executed by processing unit 910. The executable instructions can be configured to cause the processor 910 to perform the functions described herein when executing the instructions. Computer system 900 may still further include a non-volatile memory (e.g., a read only memory (ROM)) 930 to store instructions and static information for processing unit 910, and a mass storage device (e.g., a hard disk drive, a compact disc (CD) and associated CD drive, an optical disk and associated optical disk drive, a floppy disk and associated floppy disk drive, etc.) 940 that each may also be connected to bus 915 to enable each to have two-way communication across bus 915. In operation, embodiments of the present invention may be resident in processing unit 910 while being executed. For example, executing programmed instructions may cause processing unit 910 to be configured to perform the functions described herein. The computer system illustrated in FIG. 9 may provide the basic features of a computer/server system that may be used in conjunction with embodiments of the present invention.

It is contemplated that embodiments of the present invention may also be used with computer/server systems that include additional elements not included in computer system 900 in FIG. 9. For example, these addition elements may include, but are not limited to, additional processing units (e.g., parallel processing units, graphics processing units, etc.), bridges and/or interfaces to a variety of peripherals (e.g., monitor, keyboard, mouse, printer, joystick, biometric devices, speakers, external communications devices (e.g., a LAN, a WAN, a modem, a router, etc.), and other peripheral devices).

Additionally, any configuration of the computer system in FIG. 9 may be used with the various embodiments of the present invention. The executable instructions (i.e., computer program) implementing the present invention may be stored in any memory or storage device accessible to processing unit 910, for example, but not limited to, volatile memory 920, mass storage device 940, or any other local or remotely connected memory or storage device.

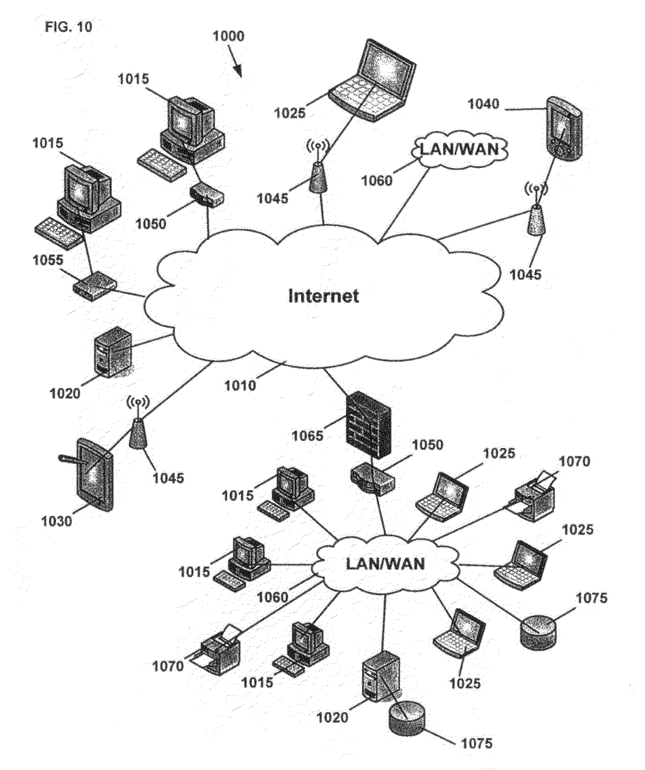

FIG. 10 is a diagram of a multiple network system that may be used together and/or separately in accordance with one or more embodiments of the present invention. In FIG. 10, Internet 1010 may have connected to it a variety of computers, servers and communications devices. For example, multiple desktop personal computers (PCs) 1015, servers 1020, lap top PCs 1025, tablet PCs 1030, and personal digital assistants (PDAs) 1040 may be connected to Internet 1010 via a variety of communications means. The communications means may include wireless access points 1045, such as seen connecting lap top PC 1025, tablet PC 1030, and PDA 1040 to Internet 1010; a router 1050, as seen connecting a desktop PC to Internet 1010; and a modem 1055, as seen connecting another desktop PC to Internet 1010. Internet 1010 may also be connected to a LAN and/or WAN 1060 via a firewall 1065 and router 1050. LAN and/or WAN 1060 in turn may be directly connected to multiple desktop PCs 1015, lap top PCs 1025, multiple printers 1070, one or more servers 1020, and one or more mass storage devices 1075, which may also be connected to one or more servers 1020. Although the diagram in FIG. 10 is not exhaustive of all of the possible configurations and implementations, it is provided to illustrate a general network structure in which embodiments of the present invention may be implemented. Therefore, additional configurations and pieces of equipment are contemplated as being used with one or more embodiments of the present invention.

Various embodiments of the present invention can provide one or more means for implementing a programming design, capable of being applied to Microsoft C/C++ programs, that can initiate parallel threads to monitor almost an unlimited amount of events reported by the operating system in a real-time environment, without any noticeable performance degradation by the user and an extremely small impact to the overall computer usage, regarding CPU cycles (percentage) and memory utilization.

Thus has been shown a method and system that can include programming parallel threads and creating a thread management system within those parallel threads that has the ability to manage the speed and priority of each executing parallel thread.

In accordance with an embodiment of the present invention, a method includes programming parallel threads and creating a thread management system within those parallel threads that has the ability to manage the speed and priority of each executing parallel thread by establishing a programming framework. The programming framework is adapted to manage the speed and priority “states” of each executing parallel thread, by calling operating system functions in a specific sequence, to efficiently control the speed and priority (efficiency) of each executing parallel thread.

In accordance with an embodiment of the present invention, a method includes programming parallel threads and creating a thread management system within those parallel threads that has the ability to manage the speed and priority of each executing parallel thread by establishing a programming framework. The programming framework is adapted to manage the speed and priority “states” of each executing parallel thread, by calling operating system functions in a specific sequence, to efficiently control the speed and priority (efficiency) of each executing parallel thread. The programming framework specifically identifies a defined technique of utilizing four operating system functions to replace the inefficient Sleep( ) function with a much more efficient environment that allows an almost unlimited number of parallel threads to function in a real-time environment, utilizing little to no CPU resources.

In accordance with one or more embodiments, each of the features of the present invention may be separately and independently claimed. Likewise, in accordance with one or more embodiments, each utility program, program, and/or code segment/module may be substituted for an equivalent means capable of substantially performing the same function(s).

In accordance with an embodiment of the present invention, a method as substantially shown and described herein.

In accordance with another embodiment of the present invention, a system and method as substantially shown and described herein.

In accordance with yet another embodiment of the present invention, a computer and method as substantially shown and described herein.

In accordance with still another embodiment of the present invention, a computer network and method as substantially shown and described herein.

Although the present invention has been disclosed in detail, it should be understood that various changes, substitutions, and alterations can be made herein. Moreover, although software and hardware are described to control certain functions, such functions can be performed using either software, hardware or a combination of software and hardware, as is well known in the art. Other examples are readily ascertainable by one skilled in the art and can be made without departing from the spirit and scope of the present invention as defined by the following claims.

What is claimed is:

1. A method of managing parallel thread execution comprising:
creating a management system for parallel thread execution;
executing an initialize utility to start executing a main thread;
creating a plurality of parallel threads to be associated with the main thread;
associating a priority value and a speed value with each of the plurality of parallel threads;
creating a thread management function to be associated with the main thread and the plurality of parallel threads; and
controlling an execution state of each of the plurality of parallel threads using the thread management function and priority and speed values associated with each parallel thread, until the main thread completes executing and ends.

2. The method of claim 1 wherein the starting the plurality of parallel threads to be associated with the at least one main thread comprises:
starting three parallel threads in association with the main thread.

3. The method of claim 2 wherein the associating the priority value and the speed value with each of the plurality of parallel threads comprises:
associating a priority value with each parallel thread; and
associating a speed value with each parallel thread.

4. The method of claim 3 wherein the controlling the execution state of each of the plurality of parallel threads using the thread management function comprises:
calling the thread management function from the parallel thread;
sending the priority value and speed value from the calling parallel thread to the thread management function;
adjusting the speed value based on the priority value in the thread management function;
sending a query from the thread management function to an operating system process/thread manager with the adjusted speed value for the parallel thread;
receiving a response from the operating system process/thread manager; and
exiting the thread management function and returning execution control back to the parallel thread.

5. The method of claim 4 wherein the adjusting the speed value based on the priority value comprises:
maintaining the speed value at a current value, if the priority value of the parallel thread is a high priority value;
increasing the speed value by 75 milliseconds, if the priority value of the parallel thread is a medium priority value; and
increasing the speed value by 200 milliseconds, if the priority value of the parallel thread is a low priority value.

6. The method of claim 5 wherein the sending the query from the thread management function to the operating system process/thread manager with the adjusted speed value causes the parallel thread cycle time to be slowed by the amount of the increase of the speed value.

7. The method of claim 4 wherein each adjustment of the speed value of the parallel thread accumulates in that speed value.

8. A machine readable medium having stored thereon a plurality of executable instructions to perform a method comprising:
creating a management system for parallel thread execution;
executing an initialize utility to start executing a main thread;
creating a plurality of parallel threads to be associated with the main thread;
associating a priority value and a speed value with each of the plurality of parallel threads;
creating a thread management function to be associated with the main thread and the plurality of parallel threads; and
controlling an execution state of each of the plurality of parallel threads using the thread management function and priority and speed values associated with each parallel thread, until the main thread completes executing and ends.

9. The machine readable medium of claim 8 wherein the starting the plurality of parallel threads to be associated with the at least one main thread comprises:
starting three parallel threads in association with the main thread.

10. The machine readable medium of claim 9 wherein the associating the priority value and the speed value with each of the plurality of parallel threads comprises:
associating a priority value with each parallel thread; and
associating a speed value with each parallel thread.

11. The machine readable medium of claim 10 wherein the controlling the execution state of each of the plurality of parallel threads using the thread management function comprises:
calling the thread management function from the parallel thread;
sending the priority value and speed value from the calling parallel thread to the thread management function;
adjusting the speed value based on the priority value in the thread management function;
sending a query from the thread management function to an operating system process/thread manager with the adjusted speed value for the parallel thread;
receiving a response from the operating system process/thread manager; and
exiting the thread management function and returning execution control back to the parallel thread.

12. The machine readable medium of claim 11 wherein the adjusting the speed value based on the priority value comprises:
maintaining the speed value at a current value, if the priority value of the parallel thread is a high priority value;
increasing the speed value by 75 milliseconds, if the priority value of the parallel thread is a medium priority value; and
increasing the speed value by 200 milliseconds, if the priority value of the parallel thread is a low priority value.

13. The machine readable medium of claim 12 wherein the sending the query from the thread management function to the operating system process/thread manager with the adjusted speed value causes the parallel thread cycle time to be slowed down by the amount added to the speed value.

14. The machine readable medium of claim 10 wherein each adjustment of the speed value of the parallel thread accumulates in that speed value.

15. An apparatus comprising a computer system including a processing unit and a volatile memory, the computer system including:
means for creating a management system for parallel thread execution;
means for executing an initialize utility to start executing a main thread;
means for creating a plurality of parallel threads to be associated with the main thread;
means for associating a priority value and a speed value with each of the plurality of parallel threads;
means for creating a thread management function to be associated with the main thread and the plurality of parallel threads; and
a thread manager configured to control an execution state of each of the plurality of parallel threads using the thread management function and priority and speed values associated with each parallel thread, until the main thread completes executing and ends.

16. The apparatus of claim 15 wherein the means for starting the plurality of parallel threads to be associated with the at least one main thread comprises:
means for starting three parallel threads in association with the main thread.

17. The apparatus of claim 16 wherein the means for associating the priority value and the speed value with each of the plurality of parallel threads comprises:
means for associating a priority value with each parallel thread; and
means for associating a speed value with each parallel thread.

18. The apparatus of claim 17 wherein the means for controlling the execution state of each of the plurality of parallel threads using the thread management function comprises:
means for calling the thread management function from the parallel thread;
means for sending the priority value and speed value from the calling parallel thread to the thread management function;
means for adjusting the speed value based on the priority value in the thread management function;
means for sending a query from the thread management function to an operating system process/thread manager with the adjusted speed value for the parallel thread;
means for receiving a response from the operating system process/thread manager; and
means for exiting the thread management function and returning execution control back to the parallel thread.

19. The apparatus of claim 18 wherein the means for adjusting the speed value based on the priority value comprises:
means for maintaining the speed value at a current value, if the priority value of the parallel thread is a high priority value;
means for increasing the speed value by 75 milliseconds, if the priority value of the parallel thread is a medium priority value; and
means for increasing the speed value by 200 milliseconds, if the priority value of the parallel thread is a low priority value.

20. The apparatus of claim 15 further comprising:
a bus connected to the processing unit and the volatile memory; and
a mass storage device connected to the bus, wherein the apparatus is adapted to operate within a threading model.

21. The apparatus of claim 20 wherein the apparatus is adapted to operate within a Microsoft threading model.
